(19) United States
(12) Patent Application Publication
(10) Pub. No.: US 2025/0033187 A1
(43) Pub. Date: Jan. 30, 2025

(54) SOCKET HOLDING FRAME

(71) Applicant: JUI CHIEN KAO, TAICHUNG CITY (TW)

(72) Inventor: JUI CHIEN KAO, TAICHUNG CITY (TW)

(21) Appl. No.: 18/357,583

(22) Filed: Jul. 24, 2023

(51) Int. Cl. B25H 3/00

(52) U.S. Cl. CPC B25H 3/003

(57) ABSTRACT

A socket holding frame has a track base and a socket holding mount. The track base has a positioning panel having multiple round locking holes arranged at spaced interval and aligned in a straight line and two side racks respectively located at two opposite sides of the positioning panel. Each side rack has a sliding channel. The socket holding mount has a round flange extending into the sliding channels of the two side racks, a holding portion formed from a top of the flange, and a positioning protrusion extending out of a bottom surface of the flange and being coaxial with the flange. The positioning protrusion is selectively mounted into one of the locking holes. The socket holding mount is rotatable relative to the track base around the positioning protrusion.

### BACKGROUND OF THE INVENTION

### 1. Field of the Invention

The present invention relates to a socket holding frame, and more particularly to a socket holding frame that facilitates a socket mounted on the socket holding frame to be rotatable or movable thereon.

### 2. Description of Related Art

A conventional socket holding frame has a track base and multiple socket holding mounts mounted on the track base. Each socket holding mount is used to hold a socket on the track base. To allow a user to adjust a position of the socket relative to the track base, each socket holding mount is slidable relative to the track base. To allow the user to look for the marks of sizes or model numbers on outer peripheries of the sockets, each socket holding mount is rotatable relative to the track base for adjusting an orientation of the socket mounted on the socket holding mount relative to the track base.

However, to move or rotate the sockets easily and quickly, the track base and the socket holding mounts do not have any fixing structure for fixing the socket holding mounts with the track base in positions. Hence, the socket holding mounts may be moved or rotated by external or unexpected impacts and cannot be firmly secured on the track base in position. Accordingly, the conventional socket holding frame provides a poor positioning effect.

To overcome the shortcomings of the conventional socket holding frame, the present invention provides a socket holding frame to mitigate or obviate the aforementioned problems.

### SUMMARY OF THE INVENTION

The present invention relates to a socket holding frame that provides a firm positioning effect and facilitates a socket mounted on the socket holding frame to rotate or to move around a central axis.

The socket holding frame comprises a track base and a socket holding mount. The track base has a positioning panel and two side racks respectively located at two opposite sides of the positioning panel. The positioning panel is elongated and has multiple round locking holes arranged at spaced intervals and aligned in a straight line. Each side rack has an upper rail panel located higher than the positioning panel, a lower rail panel, and a sliding channel formed between the upper rail panel and the lower rail panel and having an opening facing toward and communicating with the opening of the sliding channel of the other one of the two side racks. The socket holding mount is slidably and rotatably mounted on the track base and has a round flange, a holding portion, and a positioning protrusion. The flange is disposed between the upper rail panels and the lower rail panels of the two side racks and extends into the sliding channels of the two side racks via diametrical opposite sides of the flange, respectively, and is slidable relative to the sliding channels of the two side racks along the sliding channels. The holding portion is formed on and protrudes upwardly from a top of the flange and is configured to hold a socket. The positioning protrusion is formed at a bottom of the socket holding mount, extends out of a bottom surface of the flange, is coaxial with the flange, and is selectively mounted into one of the locking holes. The socket holding mount is rotatable relative to the track base around the positioning protrusion mounted into said one of the locking holes.

Other objects, advantages, and novel features of the invention will become more apparent from the following detailed description when taken in conjunction with the accompanying drawings.

### BRIEF DESCRIPTION OF THE DRAWINGS

FIG. 1 is an enlarged perspective view of a first embodiment of a socket holding frame in accordance with the present invention and shows sockets mounted thereon;

FIG. 2 is an enlarged exploded perspective view of the socket holding frame in FIG. 1;

FIG. 3 is an exploded perspective view of a socket holding mount of the socket holding frame in FIG. 1;

FIG. 4 is a side view in partial section of the socket holding frame in FIG. 1;

FIG. 5 is a cross sectional bottom view of the socket holding mount in

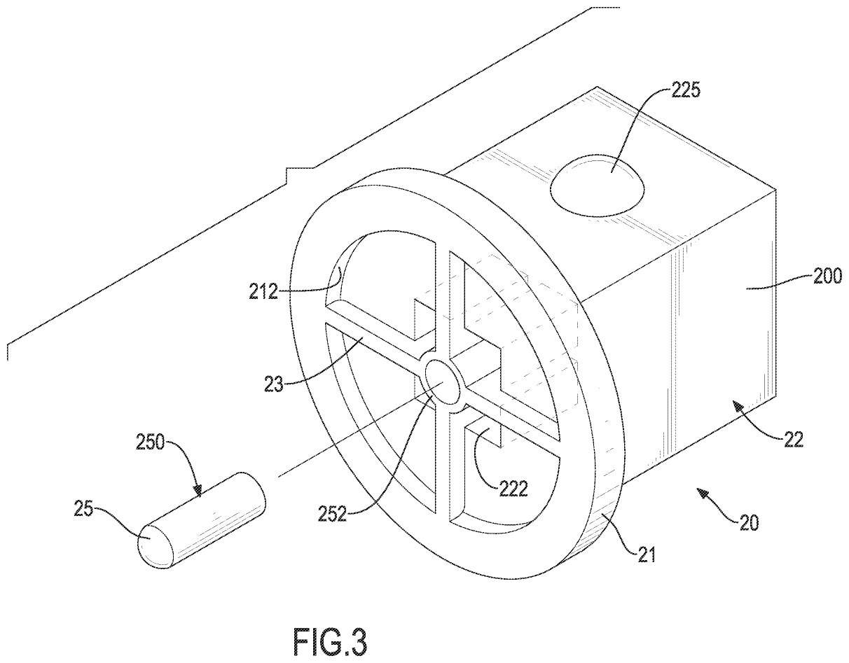

FIG. 3; and

FIG. 6 is a perspective view in partial section of the socket holding mount of a second embodiment of the socket holding frame in accordance with the present invention;

FIG. 7 is a side view in partial section of the socket holding frame in FIG. 6;

FIG. 8 is an exploded perspective view of a third embodiment of the socket holding frame in accordance with the present invention; and

FIG. 9 is a side view in partial section of the socket holding frame in FIG. 8.

### DETAILED DESCRIPTION OF PREFERRED EMBODIMENT

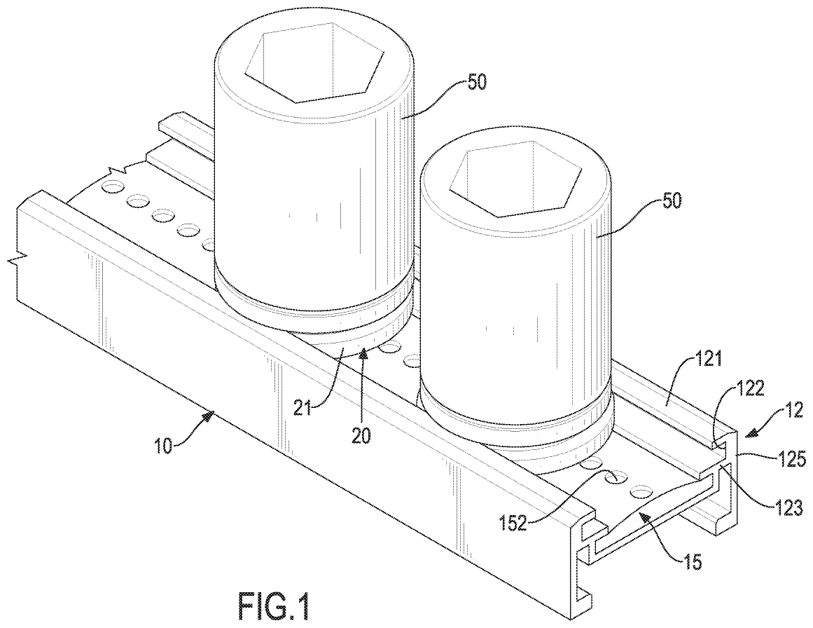

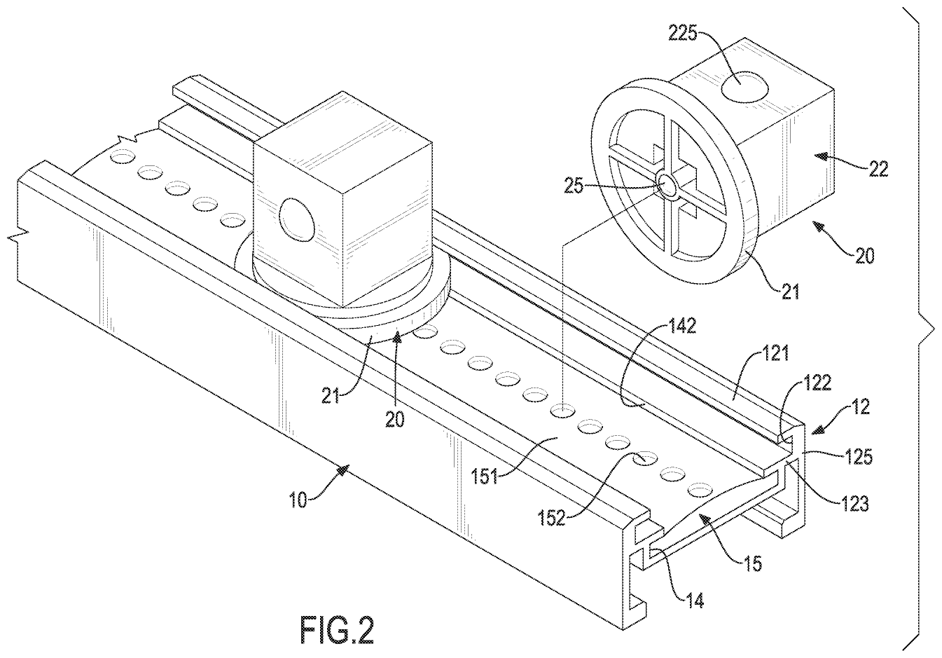

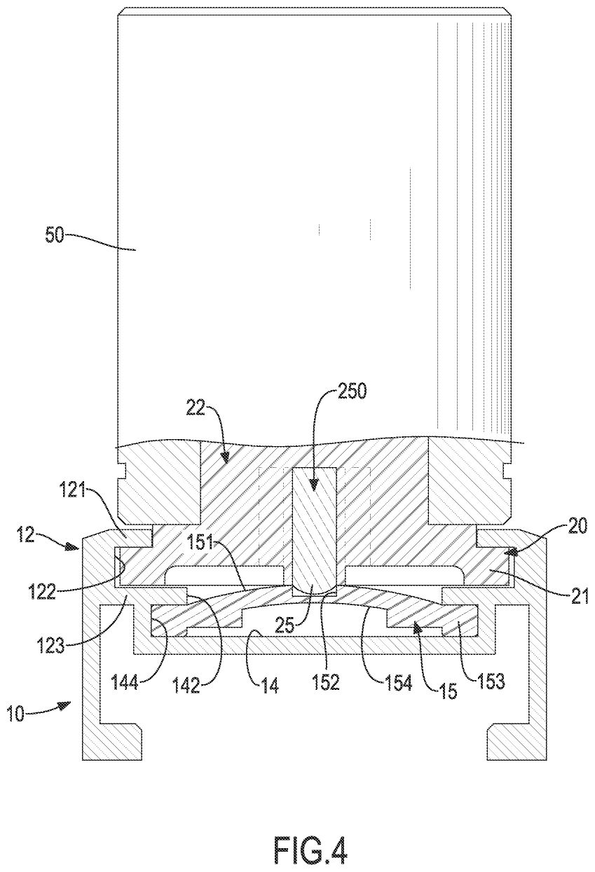

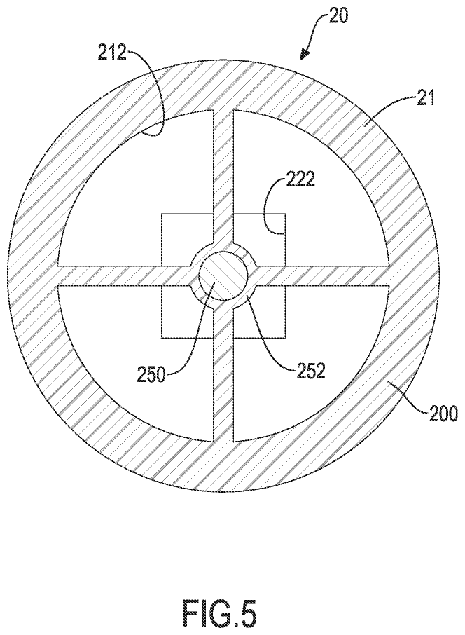

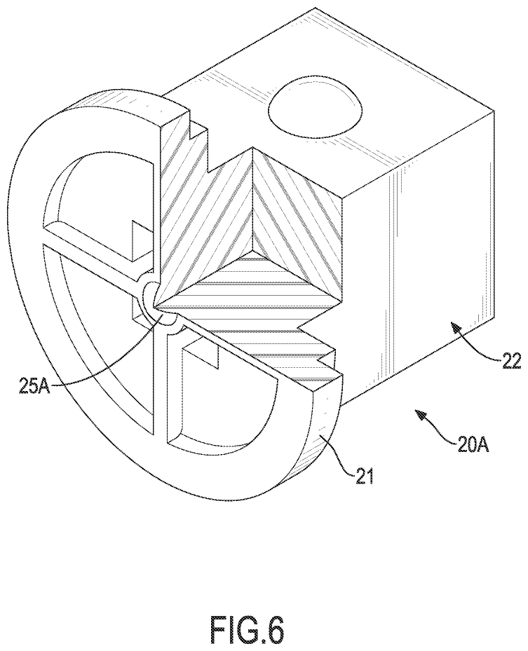

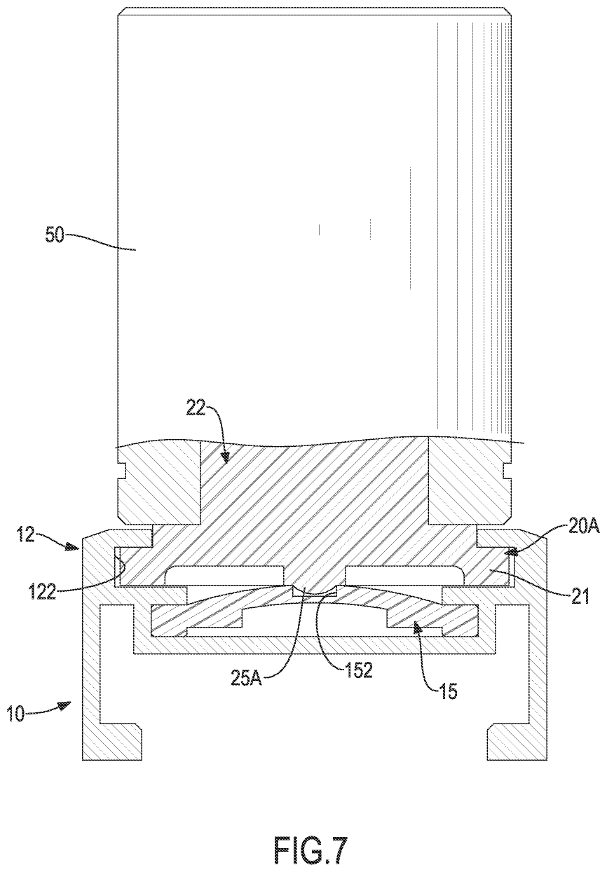

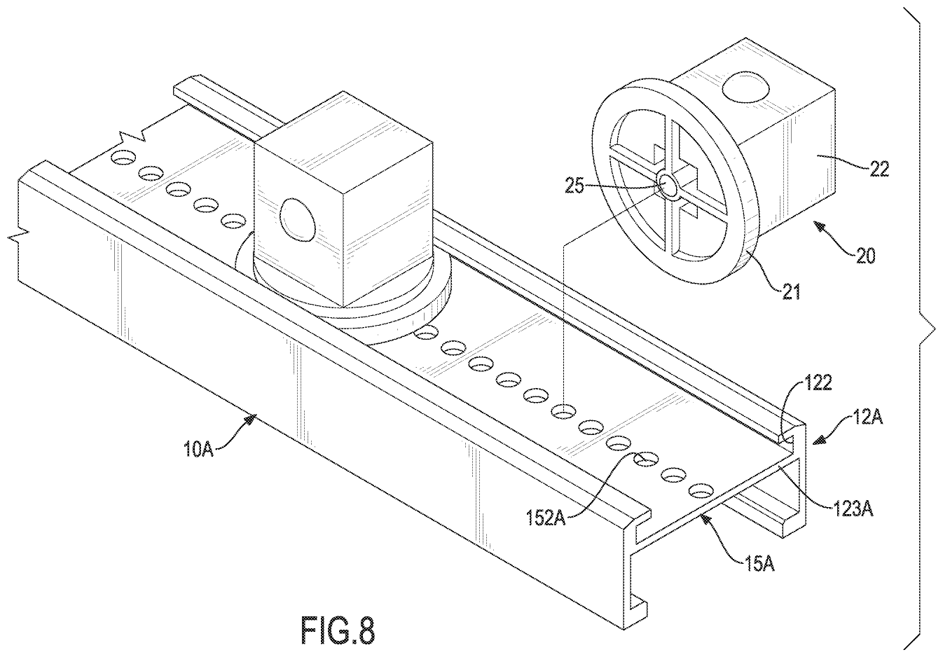

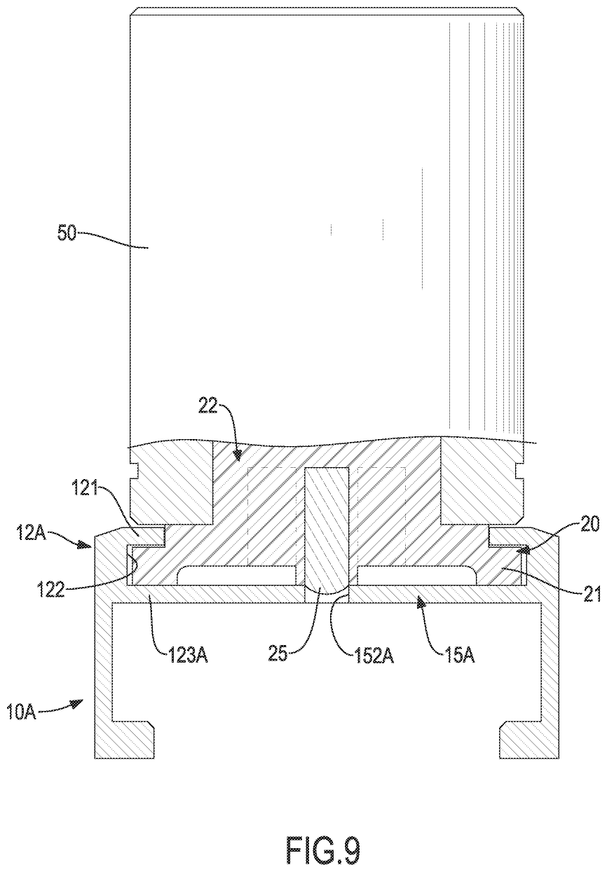

With reference to FIGS. 1 to 5, a first embodiment of a socket holding frame in accordance with the present invention comprises a track base 10 and a socket holding mount 20.

The track base 10 is made of metal, is preferably made of aluminum, is elongated, and has a positioning panel 15 and two side racks 12. The positioning panel 15 is elongated and has multiple round locking holes 152 formed in the positioning panel 15 at spaced intervals and aligned in a straight line. The two side racks 12 are respectively located at two opposite sides of the positioning panel 15. Each side rack 12 has an upper rail panel 121, a lower rail panel 123, and a sliding channel 122 formed between the upper rail panel 121 and the lower rail panel 123. The sliding channels 122 of the two side racks 12 have side openings facing toward each other and communicating with each other. The upper rail panel 121 and the lower rail panel 123 of each side rack 12 are connected by a connecting panel 125 located at a side of the side rack 12 facing away the other one of the side racks 12. The locking holes 152 are located between the two side racks 12. Each locking hole 152 may be a blind hole.

The socket holding mount 20 is slidably and rotatably mounted on the track base 10 and has a round flange 21, a holding portion 22, and a positioning protrusion 25. The flange 21 is disposed between the upper rail panels 121 and the lower rail panels 123 of the two side racks 12, extends into the sliding channels 122 of the two side racks 12 via diametrical opposite sides thereof, respectively, and is slidable relative to the track base 10 along the sliding channels 122. The holding portion 22 is formed on and protrudes upwardly from a top of the flange 21 and is configured to hold the socket 50. The holding portion 22 is rectangular and has an engaging ball 225 extending outwardly from a side surface of the holding portion 22. The positioning protrusion 25 is formed at a bottom of the socket holding mount 20, extends out of a bottom surface of the flange 21, and is coaxial with the flange 21. The positioning protrusion 25 is selectively mounted into one of the locking holes 152 to engage with the locking hole 152 and to keep the socket holding mount 20 in position. The socket holding mount 20 is rotatable relative to the track base 10 around the positioning protrusion 25 mounted into one of the locking holes 152. Preferably, a lower end of the positioning protrusion 25 is convex for the socket holding mount 20 to be easily slid by a user.

In the first embodiment, an assembling cavity 14 is located lower than the two side racks 12. An upper opening 142 is formed between the lower rail panels 123 of the two side racks 12 and communicates with the assembling cavity 14. The positioning panel 15 is an elongated panel disposed in the assembling cavity 14 and may be flexible and made of a plastic material. The positioning panel 15 has an abutting portion 151 having a convex surface facing upward and extending into the upper opening 142. The locking holes 152 are recessed in the abutting portion 151 of the positioning panel 15. Preferably, a highest point of the abutting portion 151 is located higher than top surfaces of the lower rail panels 123 of the two side racks 12 and abuts against the bottom surface of the flange 21 of the socket holding mount 20 to push the flange 21 upwardly to tightly abut against bottom surfaces of the upper rail panels 121 of the two side racks 12. The positioning protrusion 25 is able to extend into one of the locking holes 152 in the abutting portion 151 of the positioning panel 15 to keep the socket holding mount 20 in position. The assembling cavity 14 has two insertion channels 144 respectively located at two opposite sides of the assembling cavity 14 and respectively located below the two lower rail panels 123 of the two side racks 12. The positioning panel 15 has two insertion portions 153 respectively formed on two opposite sides of the abutting portion 151 and respectively inserted into the two insertion channels 144. The positioning panel 15 has a cavity 154 formed in a bottom at a middle thereof and recessed upwardly and extending longitudinally to enhance flexibility.

With reference to FIGS. 3 to 5, the socket holding mount 20 may comprise a body 200 and a positioning pin 250. The body 200 may be made of a plastic material. The flange 21 and part of the holding portion 22 are integrally formed at the body 200. The positioning pin 250 may be a round pin combined with the body 200 and has an end extending out from a bottom of the body 200. The positioning protrusion 25 is the end of the positioning pin 250 extending out from the bottom of the body 200. A hardness of the positioning pin 250 is larger than a hardness of the body 200. The positioning pin 250 may be a metal pin and is combined with the body 200 via insert molding or overmolding.

Preferably, a boss 252 is formed at the bottom of the body 200 and at a middle thereof. The positioning pin 250 is embedded into the boss 252 and has an end extending out of the boss 252. At least one depression 212 is recessed in the bottom of the body 200 and is formed between the boss 252 and the flange 21 to decrease a contacting area between the socket holding mount 20 and the positioning panel 15. At least one concavity 222 is formed around the boss 252 and extends into the holding portion 22 to decrease a volume and a weight of the socket holding mount 20. At least one rib 23 is radially connected to the boss 252 to increase structural strength of the body 200.

With reference to FIGS. 6 and 7, in the second embodiment, the positioning protrusion 25A is integrally formed with the flange 21 as a single piece.

With reference to FIGS. 8 and 9, in the third embodiment, the track base 10A is an elongated rack and may be a metal rack. The two opposite sides of the positioning panel 15A are respectively connected with the lower rail panels 123A of the two side racks 12A. A top surface of the positioning panel 15A is level with the top surfaces of the lower rail panels 123A of the two side racks 12A. The locking holes 152A are formed through the positioning panel 15A.

With reference to FIGS. 1, 4, 7, and 9, the socket 50 is detachably mounted on and around the holding portion 22 of the socket holding mount 20, 20A. The engaging ball 225 engages with a recess in an interior surface of the socket 50. Consequently, the socket 50 is positioned on the holding portion 22 of the socket holding mount 20, 20A. To adjust the position of the socket 50 relative to the track base 10, 10A, the socket 50 with the socket holding mount 20, 20A is pushed to slide along the sliding channels 122 of the two side racks 12, 12A. The positioning protrusion 25, 25A of the socket holding mount 20, 20A is released from the locking hole 152, 152A engaging with the positioning protrusion 25, 25A by the pushing force. The positioning protrusion 25, 25A can be moved to and engage with the following locking holes 152, 152A one by one, till the socket 50 is moved to a desired position. When the socket 50 is moved to the desired position, the positioning protrusion 25, 25A engages with the locking hole 152, 152A at the desired position to hold the socket holding mount 20, 20A with the socket 50 in the desired position.

When a number or a mark on the socket 50 does not face the user for ease of identification, the user may rotate the socket 50 in a clockwise or counterclockwise direction relative to the track base 10, 10A to rotate the socket 50 with the socket holding mount 20, 20A around the positioning protrusion 25, 25A relative to the track base 10, 10A to enable the number or mark of the socket 50 to face the user. Because of the positioning protrusion 25, 25A extending into one of the locking holes 152, 152A of the positioning panel 15, 15A, during the above-mentioned rotating process, the socket 50 with the socket holding mount 20, 20A is firmly and stably held in position without sliding relative to the track base 10, 10A.

In addition, the positioning panel 15 may be a flexible panel and the highest point of the abutting portion 151 of the positioning panel 15 is located higher than the top surfaces of the lower rail panels 123 of the two side racks 12. After the socket 50 is rotated to a desired direction, the abutting position 151 of the positioning panel 15 pushes the flange 21 upwardly to tightly abut against the upper rail panels 121 of the two side racks 12. Therefore, the flange 21 is tightly clamped between the upper rail panels 121 and the positioning panel 15 and is prevented from being rotated.

The track base 10, 10A may be mounted with multiple said socket holding mounts 20, 20A to allow multiple said sockets 50 to be mounted on the multiple socket holding mounts 20, 20A.

With the arrangement of the locking holes 152, 152A of the positioning panel 15, 15A spaced apart from one another and aligned in a straight line and the positioning protrusion 25, 25A protruding from the bottom of the socket holding mount 20, 20A, while the socket holding mount 20, 20A is sliding along the sliding channels 122 of the two side racks 12, 12A, the positioning protrusion 25, 25A can extend into the locking holes 152, 152A one by one for detentedly moving the socket holding mount 20, 20A. The socket holding mount 20, 20A can be firmly and securely held in position and can be rotated relative to the track base 10, 10A around the positioning protrusion 25, 25A without sliding relative to the track base 10, 10A.

What is claimed is:

1. A socket holding frame comprising:
a track base having
a positioning panel being elongated and having
multiple round locking holes arranged at spaced intervals and aligned in a straight line; and
two side racks respectively located at two opposite sides of the positioning panel, and each of the two side racks having
an upper rail panel located higher than the positioning panel;
a lower rail panel; and
a sliding channel formed between the upper rail panel and the lower rail panel and having an opening facing toward and communicating with the opening of the sliding channel of the other one of the two side racks;
a socket holding mount slidably and rotatably mounted on the track base and having
a round flange disposed between the upper rail panels and the lower rail panels of the two side racks and extending into the sliding channels of the two side racks via diametrical opposite sides of the flange, respectively, and being slidable relative to the sliding channels of the two side racks along the sliding channels;
a holding portion formed on and protruding upwardly from a top of the flange and configured to hold a socket; and
a positioning protrusion formed at a bottom of the socket holding mount, extending out of a bottom surface of the flange, being coaxial with the flange, and selectively mounted into one of the locking holes;
wherein the socket holding mount is rotatable relative to the track base around the positioning protrusion mounted into said one of the locking holes.

2. The socket holding frame as claimed in claim 1, wherein a lower end of the positioning protrusion is convex.

3. The socket holding frame as claimed in claim 2, wherein
an assembling cavity is located lower than the two side racks;
an upper opening is formed between the lower rail panels of the two side racks and communicates with the assembling cavity; and
the positioning panel is an elongated panel disposed in the assembling cavity.

4. The socket holding frame as claimed in claim 3, wherein
the positioning panel has an abutting portion having a convex surface facing upward and extending into the upper opening; and
the multiple locking holes are formed in the abutting portion of the positioning panel.

5. The socket holding frame as claimed in claim 4, wherein a highest point of the abutting portion of the positioning panel is located higher than top surfaces of the lower rail panels of the two side racks.

6. The socket holding frame as claimed in claim 2, wherein the two opposite sides of the positioning panel are respectively connected with the lower rail panels of the two side racks.

7. The socket holding frame as claimed in claim 1, wherein
the socket holding mount has a body and a positioning pin;
the flange is integrally formed at the body;
the positioning pin is combined with the body and has an end extending out of a bottom of the body; and
the positioning protrusion is the end of the positioning pin extending out of the bottom of the body.

8. The socket holding frame as claimed in claim 2, wherein
the socket holding mount has a body and a positioning pin;
the flange is integrally formed at the body;
the positioning pin is combined with the body and has an end extending out of a bottom of the body; and
the positioning protrusion is the end of the positioning pin extending out of the bottom of the body.

9. The socket holding frame as claimed in claim 3, wherein
the socket holding mount has a body and a positioning pin;
the flange is integrally formed at the body;
the positioning pin is combined with the body and has an end extending out of a bottom of the body; and
the positioning protrusion is the end of the positioning pin extending out of the bottom of the body.

10. The socket holding frame as claimed in claim 4, wherein
the socket holding mount has a body and a positioning pin;
the flange is integrally formed at the body;
the positioning pin is combined with the body and has an end extending out of a bottom of the body; and
the positioning protrusion is the end of the positioning pin extending out of the bottom of the body.

11. The socket holding frame as claimed in claim 5, wherein
the socket holding mount has a body and a positioning pin;
the flange is integrally formed at the body;
the positioning pin is combined with the body and has an end extending out of a bottom of the body; and
the positioning protrusion is the end of the positioning pin extending out of the bottom of the body.

12. The socket holding frame as claimed in claim 6, wherein
the socket holding mount has a body and a positioning pin;
the flange is integrally formed at the body;
the positioning pin is combined with the body and has an end extending out of a bottom of the body; and
the positioning protrusion is the end of the positioning pin extending out of the bottom of the body.

13. The socket holding frame as claimed in claim 1, wherein the positioning protrusion of the socket holding mount is formed integrally with the flange of the socket holding mount as a single piece.

14. The socket holding frame as claimed in claim 2, wherein the positioning protrusion of the socket holding mount is formed integrally with the flange of the socket holding mount as a single piece.

15. The socket holding frame as claimed in claim 3, wherein the positioning protrusion of the socket holding mount is formed integrally with the flange of the socket holding mount as a single piece.

16. The socket holding frame as claimed in claim 4, wherein the positioning protrusion of the socket holding mount is formed integrally with the flange of the socket holding mount as a single piece.

17. The socket holding frame as claimed in claim 5, wherein the positioning protrusion of the socket holding mount is formed integrally with the flange of the socket holding mount as a single piece.

18. The socket holding frame as claimed in claim 6, wherein the positioning protrusion of the socket holding mount is formed integrally with the flange of the socket holding mount as a single piece.
